(19) United States
(12) Patent Application Publication
(10) Pub. No.: US 2004/0143821 A1
(43) Pub. Date: Jul. 22, 2004

(54) Method and structure for converting data speculation to control speculation

(75) Inventor: Quinn A. Jacobson, Sunnyvale, CA (US)

Correspondence Address: Forrest Gunnison, Gunnison, McKay & Hodgson, L.L.P., Suite 220, 1900 Garden Road, Monterey, CA, 93940, US

(73) Assignee: Sun Microsystems, Inc.

(21) Appl. No.: 10/349,425

(22) Filed: Jan. 21, 2003

(51) Int. Cl. G06F 9/45

(52) U.S. Cl. 717/136; 717/159

(57) ABSTRACT

Data speculations are converted to control speculations in a computer program. The conversion is applied at selected locations in the computer program to eliminate the need for hardware to perform data speculation. Since data speculation is converted to control speculation, any processor that supports out-of-order execution can be used to execute the modified computer program.

### BACKGROUND OF THE INVENTION

1. Field of the Invention

The present invention relates generally to enhancing performance of processors, and more particularly to methods for data speculation.

2. Description of Related Art

To enhance the performance of modern processors, various techniques are used to enhance the number of instructions executed in a given time period. One of these techniques is data speculation.

Data speculation, in general, refers to forms of speculation where data values, either the source or result of operations, are predicted to break data dependencies. By breaking data dependencies, more instructions can be issued in parallel. Some form of checking is used to make sure that the prediction was correct, and to back up in the case of an incorrect speculation. If the speculation were correct, potentially dependent operations are executed in parallel reducing the absolute execution time.

Many forms of data speculation have been proposed to increase instruction-level parallelism (ILP) and many hardware mechanisms have been proposed to support data speculation. Data speculation is most important for long latency operations.

An example of the application of hardware based data speculation is to predict the value returned by a load instruction that misses in the memory caches close to the processor. If the value returned by the load can be predicted, subsequent instructions that depend on the value are executed while the load is still completing. When the load completes the speculation is checked and either the work done for subsequent instructions is considered correct and committed, or the work done must be discarded.

There are two fundamental things needed to make data speculation work. First, there must be a good way to predict the data value that an instruction is either going to use or to produce. The prediction could come from hardware mechanisms that observe previous behavior and use the previous behavior to predict future behavior. The prediction could also be incorporated into the software application itself.

The second thing needed for data value speculation is hardware support for speculative execution. All the subsequent instructions (that use the predicted data value) after the point of prediction must be executed in such a way that the instructions can later be committed to the architectural state, or discarded without affecting the architectural state. There must be support to remember the predicted data value used and compare the predicted data value against the actual data value returned by the instruction and to initiate either the committing or discarding of subsequent instructions.

Out-of-order (OoO) execution hardware is becoming common for high-performance processors. Out-of-order execution exposes more instruction level parallelism to reduce the execution time of programs. In out-of-order execution, a number of sequential instructions are fetched into a window where the instructions are executed according only to data dependencies, potentially out-of-order with respect to sequential order.

Out-of-order execution makes use of aggressive control speculation, predicting the outcome of conditional branches with sophisticated mechanisms, to allow more instructions to be fetched into the window. The actual outcomes of the branches are resolved as the branches are executed. As long as the predictions are correct, everything moves along. However, in the case of an incorrect prediction, all instructions older than the branch in the instruction window are squashed and a fetch is redirected to the correct instruction sequence.

In addition to control speculation, another key element of aggressive out-of-order processors is register renaming. Register renaming is a mechanism by which the architected register names used within a program are translated into a potentially larger set of internal, often called physical, register names.

A single architected register may be mapped into multiple physical registers corresponding to different uses of the architected register at different points in the sequential representation of the program. There are a number of reasons that register renaming is important.

One of the reasons is that register renaming can make backing up execution in response to bad speculation easier. The register state prior to the point of bad speculation coexists with the register state after the speculation and backing up to the earlier state can be achieved by just changing the mapping of architected register names to physical register names.

Another import benefit of register renaming is that register renaming breaks artificial write-after-write dependencies of the sequential representation of the program. For example, assume a sequence of four instructions. A first instruction produces a result that's destination is register A. A second instruction has register A as a source register. A third instruction is independent of the earlier two instructions but uses register A as a destination register and a fourth instruction uses the result of the third instruction.

The first and third instructions can actually be executed in parallel as long as the instructions are given different physical registers for their results and the rename hardware keeps track that architected register A maps to both of the physical registers depending on where in the sequential instructions sequence the execution process is. The second and third instructions can also be potentially executed in parallel and use the appropriate physical register as the source.

### SUMMARY OF THE INVENTION

According to one embodiment of the present invention, data speculations are converted to control speculations in a computer program. The conversion is applied at selected locations in the computer program to provide the benefit of data speculation while eliminating the need for hardware to perform data speculation.

Since data speculation is converted to control speculation, any processor that supports out-of-order execution can be used to execute the modified computer program. The conversion of data speculation to control speculation allows existing hardware to be used efficiently for implementing important forms of data speculation. For example, in one embodiment, load value data speculation is converted to control speculation.

In one embodiment, a computer program is modified so that upon execution of the computer program data speculations are converted to control speculations. The computer program is modified by a computer-based method that converts a data speculation to a control speculation by inserting an instruction in the computer program that sets a value of an item, for which data speculation is desired, to an expected value upon a predefined condition being true. The method also inserts an instruction for comparing a value of the item to the expected value. In this embodiment, the predefined condition being true is the value of the item being equal to the expected value.

In another embodiment, a computer program also is modified so that upon execution of the computer program data speculations are converted to control speculations. In this embodiment, the computer program is modified by a computer-based method that converts a data speculation to a control speculation by inserting an instruction for comparing a value of the item, for which data speculation is desired, to an expected value of the item.

One embodiment of a structure suitable for performing the above method includes means for converting a data speculation to a control speculation in a computer program. The means for converting a data speculation to a control speculation includes means for inserting an instruction in the computer program that sets a value of item, for which data speculation is desired, to an expected value upon a predefined condition being true. The structure also includes means for inserting an instruction for comparing a value of the item to the expected value.

These means can be implemented, for example, by using stored computer executable instructions and a processor in a computer system to execute these instructions. The computer system can be a workstation, a portable computer, a client-server system, or a combination of networked computers, storage media, etc.

Another embodiment of the structure is a computer system that includes a processor, and a memory coupled to the processor. Computer executable instructions for the method are stored in the memory. Execution of the computer executable instructions on the processor results in the method.

For this embodiment, a computer-program product is a medium configured to store or transport computer readable code for a method including:

converting a data speculation to a control speculation in a computer program, the converting the data speculation to the control speculation including:

inserting an instruction in the computer program that sets a value of item, for which data speculation is desired, to an expected value upon a predefined condition being true.

The method further includes inserting an instruction for comparing a value of the item to the expected value. In this embodiment, the predefined condition being true is the value of the item being equal to the expected value.

For another embodiment, a computer-program product is a medium configured to store or transport computer readable code for a method including:

converting a data speculation to a control speculation in a computer program, the converting the data speculation to the control speculation including:

inserting an instruction in the computer program for comparing a value of item, for which data speculation is desired, to an expected value of the item.

In still another embodiment of the invention, a method converts a data speculation to a control speculation by comparing an expected value of an item, for which data speculation is desired, with a current value of the item. The method sets the value of the item to the expected value upon the expected value of the item equaling the current value of the item. Alternatively, the method continues without setting the value of the item to the expected value upon the expected value of the item not equaling the current value of the item.

A structure suitable for performing this method includes means for comparing an expected value of an item, for which data speculation is desired, with a current value of the item. The structure also includes means for setting the item to the expected value upon the expected value of the item equaling the current value of the item. The structure further includes means for continuing without setting the item to the expected value upon the expected value of the item not equaling the current value of the item.

These means can be implemented, for example, by using stored computer executable instructions and a processor in a computer system to execute these instructions. The computer system can be a workstation, a portable computer, a client-server system, or a combination of networked computers, storage media, etc.

Another embodiment of the structure is a computer system that includes a processor, and a memory coupled to the processor. Computer executable instructions for the method are stored in the memory. Execution of the computer executable instructions on the processor results in the method.

For this embodiment, a computer-program product is a medium configured to store or transport computer readable code for a method including:

comparing an expected value of an item, for which data speculation is desired, with a current value of the item;

setting the item to the expected value upon the expected value of the item equaling the current value of the item; and

continuing without setting the item to the expected value upon the expected value of the item not equaling the current value of the item.

In still yet another embodiment of this invention, a method for converting a data speculation to a control speculation includes copying a value stored in a first register, a first storage location, to another available register, a second storage location. The value in the first storage location is a current value of an item for which data speculation is desired. An expected value of the item is compared with the current value of the item. The item is set to the expected value upon the expected value of the item equaling the current value of the item. The value in the first register is reset to it original state upon the expected value of the item not equaling the current value of the item.

A structure for implementing this embodiment of the method includes means for copying a current value of an item, for which data speculation is desired, stored in a register. The structure also includes means for comparing an expected value of the item with the current value of the item; means for setting the item to the expected value upon the expected value of the item equaling the current value of the item; and means for restoring the register to it original value upon the expected value of the item not equaling the current value of the item.

These means can be implemented, for example, by using stored computer executable instructions and a processor in a computer system to execute these instructions. The computer system can be a workstation, a portable computer, a client-server system, or a combination of networked computers, storage media, etc.

### BRIEF DESCRIPTION OF THE DRAWINGS

FIG. 1A is a block diagram of a system that includes a data-to-control speculation method module according to a first embodiment of the present invention.

FIG. 1B is a block diagram of a system that includes a data-to-control speculation method module according to a second embodiment of the present invention.

FIG. 2 is a process flow diagram for one embodiment of the present invention.

### DETAILED DESCRIPTION

According to one embodiment of the present invention, data speculations are converted to control speculations in a computer program. The conversion is applied at selected locations in the computer program to eliminate the need for hardware to perform data speculation. Since data speculation is converted to control speculation, any processor that supports out-of-order execution can be used to execute the modified computer program.

Hence, the conversion of data speculation to control speculation in the computer program allows existing hardware to be used efficiently for implementing important forms of data speculation. For example, in one embodiment, load value data speculation is converted to control speculation, as described more completely below.

In one embodiment, a data-to-control speculation method 140A is used with a compiler or optimizing interpreter (compiler/optimizing interpreter) 150, in processing a source program 130, to insert instructions that convert data speculation into control speculation. Data-to-control speculation method 140A inserts a general sequence of a few instructions 161, 162, sometimes called code segments 161, 162, at points of computer executable program 160 where data speculation is desired as specified by data in insertion data point information 145A. Insertion data point information 145A, for example, includes the item for which data speculation is desired, the location of the item, and an expected value of the item.

Inserted instruction sequences 161, 162 do not change the semantics of program 160 at all. The conversion makes use of existing instructions and the resulting converted program 160 is both forward and backwards compatible.

Converted program 160 makes use of existing support for out-of-order execution, e.g., an out-of-order execution module 177 in a processor 170. Existing support for branch prediction is used to checkpoint program 160 at the point where control speculation code was inserted. Existing branch mispredict recover logic in processor 170 is used to recover from the speculation, if necessary. Register renaming is used to break data dependencies, if required. Out-of-order execution is used to execute the speculative code in parallel.

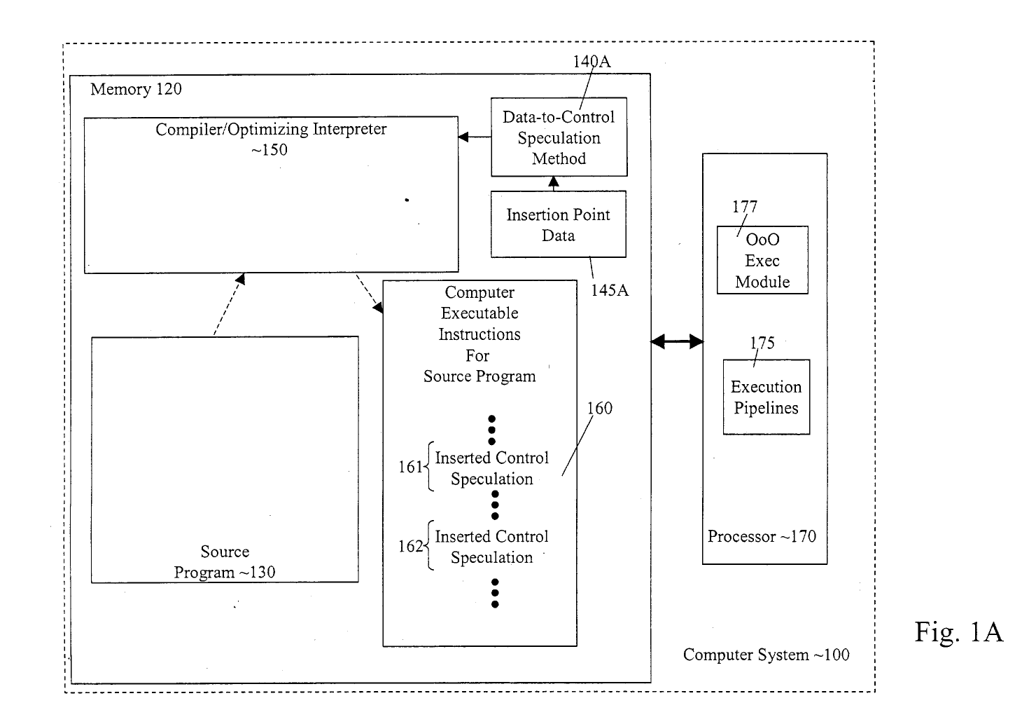

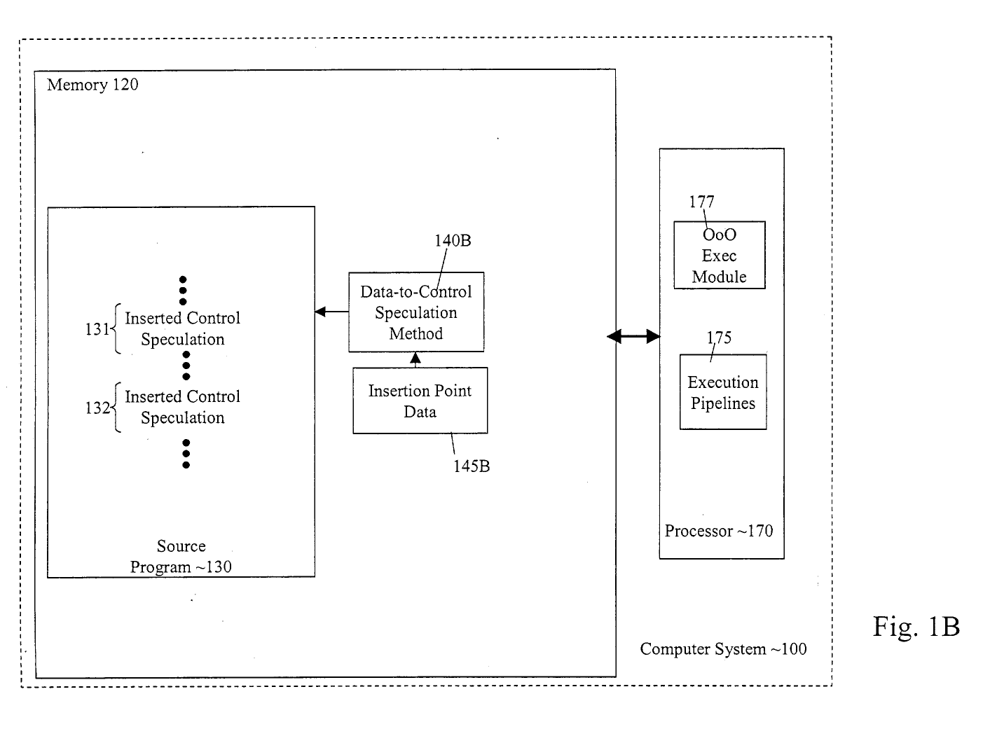

In another embodiment, method 140B (FIG. 1B) inserts a general sequence of a few instructions 131, 132, sometimes called code segments 131, 132, at points of computer source program 130 where data speculation is desired. Specifically, method 140B uses data in insertion data point information 145A to insert a sequence of control speculation instructions at each insert point specified in information 145A. Instruction sequences 131, 132 do not change the semantics of source program 130 at all. The conversion makes use of existing instructions and the resulting converted source program 130 is both forward and backwards compatible.

In the embodiments of FIGS. 1A and 1B, the inserted control speculation instructions are a straightforward sequence of instructions. However, the specific implementation of this sequence of instructions is dependent upon factors including some or all of (i) the computer programming language used in source program 130, (ii) the operating system used on computer system 100 and (iii) the instruction set for processor 170. In view of this disclosure, those of skill in the art can implement the conversion in any system of interest where out-of-order execution is supported.

Multiple equivalent code segments can be used to implement data-to-control speculation conversion. In this embodiment, the code segment is inserted at an insertion point.

This embodiment of the inserted code segment compares a value of an item, for which data speculation is desired, with an expected value of that item, typically using a conditional flow-control instruction. The expected value may either be a constant value, another value available at that time (for example a value in another register), or even a value that can be computed. Also, the value may be an address, or used as part of a subsequent address calculation.

If the values match, the value of the item is set to the expected value and control is directed back to the point in the computer program after the inserted code segment. If the values do not match, any necessary clean up is performed and control is transferred to the point in the computer program after the inserted code segment.

Stated in general terms, the functional equivalence of the execution of the inserted code segment can be stated as, if the actual value of the operation at the time of speculation matches the expected value of the operation then set the value to the expected value otherwise set the value to the actual value. If the actual value matches the expected value, it is redundant, but does not change the value, to set the value to the expected value.

Thus, the inserted code segment includes an operation that sets the value of an item to the expected value of that item. The set operation breaks the dependency for out-of-order hardware 177. Subsequent instructions that use the architected value of the item get the value from the operation that sets value to the expected value and not from the real source. This assumes that the expected value is known before the actual value can be determined.

Subsequent instructions are able to execute as soon as the value of the item is set to the expected value, and do not have to wait for the actual value of the item to be determined. This is the manifestation of data speculation that is obtained by converting the data speculation to a control speculation. In the case that the actual value does not equal the expected value, the hardware suffers a branch mispredict and the speculatively executed instructions are squashed and re-executed with the correct value.

As described above, method 140, where method 140 represents both method 140A and 140B, begins operation at known points where data speculation is desirable. In one embodiment, software identifies each instruction, on which to speculate on the value that results from execution of the instruction. This can be done from programmer directives, compiler analysis, or profiler feedback. Independent of the process used to identify the instructions, the process makes the decision that it is potentially beneficial to break the data dependency by speculating on the result value of an operation.

To further illustrate method 140, pseudo code for various examples are presented below. An example pseudo code segment selected for data speculation is presented in TABLE 1.

TABLE 1

1 Producer_OP A, B -> %rZ
2 Consumer_OP %rZ, C -> D
......

Line 1 (The line numbers are not part of the pseudo code and are used for reference only.) is an operation, Producer_OP, that uses items A and B and places the result of the operation in register % rz. Operation Producer_OP can be any operation supported in the instruction set. Items A and B are simply used as placeholders to indicate that this particular operation requires two inputs. The various embodiments of this invention are also applicable to an operation that has a single input, or more than two inputs. Register % rZ can be any register. The result of operation Producer_OP is not available until after a long latency, and the result is expected to be of value N, where N is either an absolute value or a value available in a register.

Line 2 is an operation Consumer_OP. Operation Consumer_OP uses the result of operation Producer_OP that is stored in register % rZ. Items C and D are simply used as place holders to indicate that this particular operation requires two inputs % RZ and C and has an output D.

The pseudo code generated by using method 140A for the pseudo code in TABLE 1 is presented in lines Insert_{—}1 to Insert_{—}7 of TABLE 2.

TABLE 2

1 Producer_OP A, B -> %rZ
Insert_21 !!!!!!! BEGIN INSERTED CODE !!!!!!!!!!
Insert_22 cmp %rZ, N
Insert_23 bne EXIT_TARGET
Insert_24 nop
Insert_25 mov N -> %rZ
Insert_26 EXIT_TARGET:
Insert_27 !!!!!!!!! END INSERTED CODE !!!!!!!!!!
2 Consumer_OP %rZ, C -> D

Again, the line numbers are not part of the pseudo code and are used for reference only.

In this example, line 1 is identified as an insertion point and so a code segment, including lines Insert_{—}21, Insert_{—}22, Insert_{—}23, Insert_{—}24, Insert_{—}25, Insert_{—}26 and Insert_{—}27, is inserted after line 1. Line Insert_{—}21 is a comment line. Lines Insert_{—}22 and Insert_{—}23 are one example of a conditional flow control instruction. Line Insert_{—}22 compares the value in register % rZ with expected value N of operation Producer_OP. Line Insert_{—}23 branches to label EXIT_TARGET if the value in register % rZ is not equal to expected value N of operation Producer_OP.

Line Insert_{—}24 is a no operation instruction and functions as a delay slot of the branch, assuming an instruction set with delayed branches. Line Insert_{—}25 moves expected value N to register % rZ, i.e., sets the result of operation Producer_OP to the expected value.

Line Insert_{—}26 is label EXIT_TARGET that instruction one branches to when the value in register % rZ is not equal to expected value N of operation Producer_OP. Line Insert_{—}27 is a comment line.

When the code segment in TABLE 2 is executed on processor 170, out of order execution hardware 177 recognizes that using control speculation for the window defined by at least lines Insert_{—}21 through 2 allows these lines to be executed before line 1 is executed, or in parallel with line 1. Therefore, the conversion of method 140A enhances the instruction level parallelism of the program without requiring any specialized hardware to perform the data speculation as to the value of operation Producer_OP.

Another embodiment of pseudo code generated by using method 140A for the pseudo code in TABLE 1 is presented in lines Insert_{—}31 to Insert_{—}37 of TABLE 3.

TABLE 3

1 Producer_OP A, B -> %rZ
Insert_31 !!!!!!!! BEGIN INSERTED CODE !!!!!!!!!!
Insert_32 copy %rZ -> %temp
Insert_33 move N -> %rZ
Insert_34 branch if equal %temp and N EXIT_TARGET
Insert_35 nop
Insert_36 mov %temp -> %rZ
Insert_37 EXIT_TARGET:
Insert_38 !!!!!!!!! END INSERTED CODE !!!!!!!!!!!
2 Consumer_OP %rZ, C -> D

Again, the line numbers are not part of the pseudo code and are used for reference only.

In this example, line 1 is identified as an insertion point and so a code segment, including lines Insert_{—}31, Insert_{—}32, Insert_{—}33, Insert_{—}34, Insert_{—}35, Insert_{—}36, and Insert_{—}37, is inserted after line 1. Line Insert_{—}31 is a comment line. Line Insert_{—}32 copies the value in register % RZ to a temporary register % temp. Line Insert_{—}33 moves expected value N of operation Producer_OP to register % RZ. This effectively sets the result of operation Producer_OP to expected value N.

Line Insert_{—}34 is another example of a conditional flow control instruction. Execution of line Insert_{—}34 compares the value in register % temp with expected value N of operation Producer_OP. If the two values are equal, processing branches to line Insert_{—}37, and otherwise to line Insert_{—}35.

Line Insert_{—}35 is a no operation instruction and functions as a delay slot of the branch, assuming an instruction set with delayed branches. Line Insert_{—}36 moves the value in register % temp to register % rZ, i.e., restores the value of register % rZ.

Line Insert_{—}37 is label EXIT_TARGET that the instruction in Line Insert_{—}34 branches to when the value in register % temp is equal to expected value N of operation Producer_OP. Line Insert_{—}38 is a comment line.

When the code segment in TABLE 3 is executed on processor 170, out of order execution hardware 177 recognizes that using control speculation for the window defined by at least lines Insert_{—}31 through 2 allows these lines to be executed before line 1 is executed, or in parallel with line 1. Therefore, this embodiment of the conversion of method 140A enhances the instruction level parallelism of the program without requiring any specialized hardware to perform the data speculation as to the value of operation Producer_OP. The example of TABLE 3 is equivalent to the example of TABLE 2.

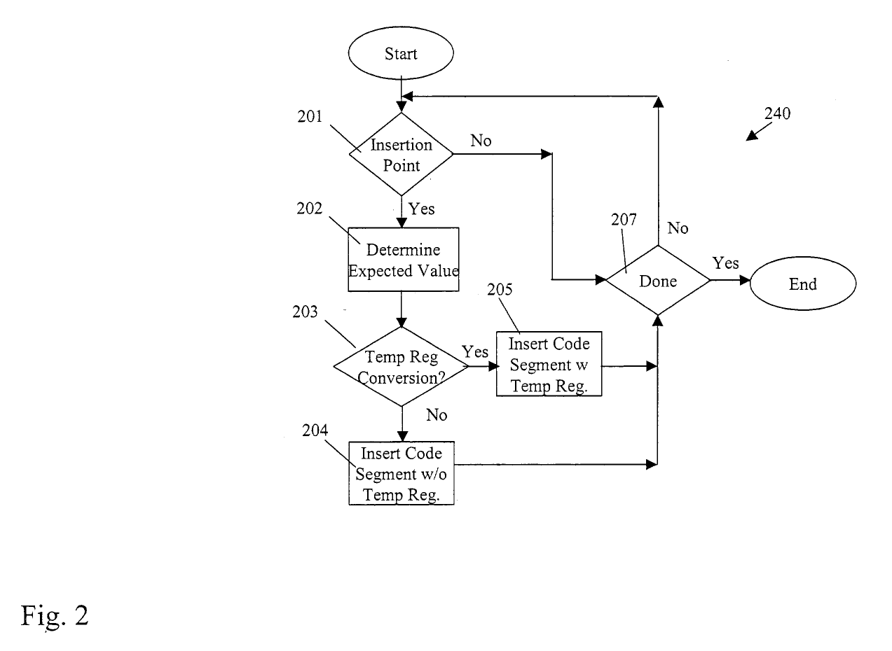

FIG. 2 is a process flow diagram 240 for one embodiment of data-to-control speculation methods 140A and 140B. Insertion point check operation 201 determines whether a point in a computer program, e.g., either program 160 (FIG. 1A) or program 130 (FIG. 1B), has been reached where it is desired to perform data speculation on an item, e.g., a variable, a pointer, an address, etc. At this point, there is a known expected value for the item that is the subject of the data speculation. When an insertion point is reached in the computer program, check operation 201 transfers to determine expected value operation 202.

In an insertion point is not reached, insertion point check operation 201 transfers to done check operation 207. If the computer program has been processed, done check operation transfers to end operation and otherwise returns to insertion point check operation 201.

Determine expected value operation 202 determines an expected value of the item for which speculative execution is desired. In one embodiment, the expected value is retrieved from the insertion point data set, because the expected value was previously determined and saved. In another embodiment, the expected value is determined from the source program in operation 202. Upon completion of operation 202, processing transfers to temporary register conversion check operation 203.

Temporary register conversion check operation 203 determines whether a code segment that utilizes a temporary register as in Table 3 is specified, or a code segment that does not utilize a temporary register as in Table 2 is specified. In one embodiment, the selection is made in response to a user input. In another embodiment, the selection is made based upon whether use of the temporary register assists in increasing instruction parallelism.

If use of a temporary register is specified, check operation 203 transfers to insert code segment with temporary register operation 205 and otherwise to insert code segment without temporary register operation 204.

Operations 204, 205 insert code segments equivalent to those in Tables 2 and 3, respectively. Operations 204 and 205 are not limited to the specific code segments described above. The functions performed by these segments can be implemented by those of skill in the art in a wide variety of ways. Process flow diagram 240 is intended to demonstrate the operations performed by the data-to-control speculation conversion and not the specific instructions or number of instructions used to implement the conversion. Operations 204, 205 transfer to done check operation 20.7.

Done check operation 207 determines the computer program has been processed. If additional code statements remain for processing, check operation 207 transfers to insertion point check operation 201 and otherwise method 240 is complete.

In yet another embodiment, a block of source code is inserted that uses the expected value of the producer operation. Table 4 is pseudo code that illustrates one example of this embodiment.

TABLE 4

1 Producer_OP A, B -> %rZ
2 Block of code that uses %rZ
......

The use of block does not indicate any particular structure. The term is intended to denote the part of the source code that uses the value in register % RZ generated by execution of instruction Producer_OP. In the example of TABLE 1, a block is a single line of code.

One a embodiment of pseudo code generated by using method 140A for the pseudo code in TABLE 4 is presented in lines Insert_{—}51 to Insert_{—}55 of TABLE 5.

TABLE 5

| 1 Producer_OP A, B -> %rZ | |
|---|---|
| Insert_51 | !!!!!!!! BEGIN INSERTED CODE !!!!!!!!!! |
| Insert_52 | if %rZ = N |
| Insert_53 | block of code that uses %rZ with %rZ |
| | set equal to N |
| Insert_54 | else |
| Insert_55 | !!!!!!!!! END INSERTED CODE !!!!!!!!!!! |
| 2 | Block of code that uses %rZ |

In this example, line 1 is identified as an insertion point and so a code segment, including lines Insert_{—}51, Insert_{—}52, Insert_{—}53, Insert_{—}54, and Insert_{—}55, is inserted after line 1. It is noted that line Insert_{—}53 can be multiple lines of code and so line Insert_{—}53 is a reference numeral for the block of code.

Line Insert_{—}51 is a comment line. Line Insert_{—}52 is an example of a conditional flow control statement. If the value in register % rZ equals expected value N of operation Producer_OP, processing transfers from line Insert_{—}52 to line Insert_{—}53 and otherwise to line Insert_{—}54. Line Insert_{—}55 is a comment line.

Thus, in this example, if the value in register % rZ equals expected value N of operation Producer_OP, the block of code is executed with the value of register % RZ set equal to N. Otherwise, original block of code is executed.

Certain processor microarchitectures benefit much more from the transformation than others do. For some processors, the transformation may be able to significantly increase the amount of instruction-level parallelism (ILP), while for other processor configurations the transformation may only produce an overhead that slightly slows execution.

The data speculation to control speculation conversion is legal to use anywhere in a program for most any architected state. The conversion provides a performance benefit for certain situations. The conversion adds overhead to the software application from the added instructions. When appropriately applied the benefit from the conversion should far out weigh the overhead. If the benefit is not observed because of either the software application behavior or hardware behavior the overhead slows down execution of the software application.

For the transformation to be beneficial, the software application ideally has three characteristics. First, there must be an operation for which the result is available after a long latency. The most common cause would be a long latency operation like a load that frequently misses the caches. Second, the result of the operation is predictable. Third, subsequent operations are dependent on the result of the operation.

For the transformation to be beneficial, the hardware also ideally has three characteristics. First, the hardware must support out-of-order execution. Second, the instruction window must be large enough to hold a significant amount of work after the speculation conversion. Third, the processor must support enough out-of-order resolution to allow significant progress. Things like out-of-order branch resolution potentially help significantly.

One of the most likely candidates for this transformation is to implement load value speculation. Profile directed feedback, or some other mechanism, is used to identify load instructions that commonly miss the cache and that have predictable values returned.

Assume an aggressive out-of-order processor runs the code. For each of the identified load candidates, the conversion is applied. The conversion can be easily incorporated as a late stage conversion with profile directed feedback.

Table 6 is an example of a pseudo-assembly code segment before transformation.

TABLE 6

LD [A] -> %rZ
Consumer_OP %rZ, C -> D
......

The expected value of load operation LD is N.

TABLE 7 is an example of a pseudo-assembly code segment after the data speculation to control speculation transformation is applied to the pseudo code of TABLE 6.

TABLE 7

LD [A] -> %rZ
!!!!!!!!! BEGIN INSERTED CODE !!!!!!!!!!!!!!!!!!
cmp %rZ, N
bne EXIT_TARGET
nop
mov N -> %rZ
EXIT_TARGET:
!!!!!!!!!! END INSERTED CODE !!!!!!!!!!!!!!!
Consumer_OP %rZ, C -> D

In view of the above discussion of TABLES 1 and 2 above, the interpretation of TABLES 6 and 7 follows. In view of this disclosure, an operation for which data speculation if performed using control speculation can have any number of arguments, etc. so long as the result of the operation has an expected value.

Those skilled in the art readily recognize that in this embodiment the individual operations mentioned before in connection with methods 140A and 140B, are performed by executing computer program instructions on processor 170 of computer system 100. In one embodiment, a storage medium has thereon installed computer readable program code for method 140, where method 140 is either or both of methods 140A and 140B, and execution of the computer-readable program code causes the processor 170 to perform the individual operations explained above.

In one embodiment, computer system 100 is a hardware configuration like a personal computer or workstation. However, in another embodiment, computer system 100 is a client-server computer system. For either a client-server computer system or a stand-alone computer system, memory 120 typically includes both volatile memory, such as main memory, and non-volatile memory, such as hard disk drives.

While memory 120 is illustrated as a unified structure, this should not be interpreted as requiring that all memory in memory 120 is at the same physical location. All or part of memory 120 can be in a different physical location than processor 170. For example, method 140 may be stored in memory that is physically located in a location different from processor 170.

Processor 170 should be coupled to the memory containing method 140. This could be accomplished in a client-server system, or alternatively via a connection to another computer via modems and analog lines, or digital interfaces and a digital carrier line. For example, all of part of memory 120 could be in a World Wide Web portal, while processor 170 is in a personal computer, for example.

More specifically, computer system 100, in one embodiment, can be a portable computer, a workstation, a server computer, or any other device that can execute method 140. Similarly, in another embodiment, computer system 100 can be comprised of multiple different computers, wireless devices, server computers, or any desired combination of these devices that are interconnected to perform, method 140 as described herein.

Herein, a computer program product comprises a medium configured to store or transport computer readable code for method 140 or in which computer readable code for method 140 is stored. Some examples of computer program products are CD-ROM discs, ROM cards, floppy discs, magnetic tapes, computer hard drives, servers on a network and signals transmitted over a network representing computer readable program code.

Herein, a computer memory refers to a volatile memory, a non-volatile memory, or a combination of the two. Similarly, a computer input unit and a display unit refer to the features providing the required functionality to input the information described herein, and to display the information described herein, respectively, in any one of the aforementioned or equivalent devices.

In view of this disclosure, method 140 can be implemented in a wide variety of computer system configurations using an operating system and computer programming language of interest to the user. In addition, method 140 could be stored as different modules in memories of different devices. For example, method 140 could initially be stored in a server computer, and then as necessary, a module of method 140 could be transferred to a client device and executed on the client device. Consequently, part of method 140 would be executed on the server processor, and another part of method 140 would be executed on the processor of the client device.

In yet another embodiment, method 140 is stored in a memory of another computer system. Stored method 140 is transferred, over a network to memory 120 in system 100.

Method 140 is implemented, in one embodiment, using a computer program. The computer program may be stored on any common data carrier like, for example, a floppy disk or a compact disc (CD), as well as on any common computer system's storage facilities like hard disks. Therefore, one embodiment of the present invention also relates to a data carrier for storing a computer program for carrying out the inventive method. Another embodiment of the present invention also relates to a method for using a computer system for carrying out method 140. Still another embodiment of the present invention relates to a computer system with a storage medium on which a computer program for carrying out method 140 is stored.

While method 140 hereinbefore has been explained in connection with one embodiment thereof, those skilled in the art will readily recognize that modifications can be made to this embodiment without departing from the spirit and scope of the present invention.

I claim:

1. A computer-based method comprising:
converting a data speculation to a control speculation in a computer program, said converting said data speculation to said control speculation comprising:
inserting an instruction in said computer program that sets a value of an item, for which said data speculation is desired, to an expected value upon a predefined condition being true.

2. The method of claim 1 further comprising:
inserting an instruction for comparing a value of said item to said expected value.

3. The method of claim 2 wherein said predefined condition being true comprises said value of said item being equal to said expected value.

4. A structure comprising:
means for converting a data speculation to a control speculation in a computer program, said converting said data speculation to said control speculation comprising:
means for inserting an instruction in said computer program that sets a value of an item, for which said data speculation is desired, to an expected value upon a predefined condition being true.

5. The structure of claim 4 further comprises:
means for inserting an instruction for comparing a value of said item to said expected value.

6. The structure of claim 5 wherein said predefined condition being true comprises said value of said item being equal to said expected value.

7. A computer-program product comprising a medium configured to store or transport computer readable code for a method comprising:
converting a data speculation to a control speculation in a computer program, said converting said data speculation to said control speculation comprising:
inserting an instruction in said computer program that sets a value of an item, for which said data speculation is desired, to an expected value upon a predefined condition being true.

8. The computer-program product of claim 7 wherein said method further comprises:
inserting an instruction for comparing a value of said item to said expected value.

9. The computer-program product of claim 8 wherein said predefined condition being true comprises said value of said item being equal to said expected value.

10. A computer system comprising:
a processor; and
a memory coupled to said processor and having stored therein instructions for a data speculation to a control speculation conversion method wherein upon execution of said instructions on said processor, said method comprises:
converting a data speculation to a control speculation in a computer program, said converting said data speculation to said control speculation comprising:
inserting an instruction in said computer program that sets a value of an item, for which said data speculation is desired, to an expected value upon a predefined condition being true.

11. The computer system of claim 10 wherein said method further comprises:
inserting an instruction for comparing a value of said item to said expected value.

12. The computer system of claim 11 wherein said predefined condition being true comprises said value of said item being equal to said expected value.

13. A computer-based method comprising:
converting a data speculation to a control speculation in a computer program, said converting said data speculation to said control speculation comprising:
inserting an instruction in said computer program that compares a value of an item, for which said data speculation is desired, to an expected value of said item.

14. A method for converting a data speculation to a control speculation comprising:
comparing an expected value of an item, for which data speculation is desired, with a current value of said item;
setting said item to said expected value upon said expected value of said item equaling said current value of said item; and
continuing without setting said item to said expected value upon said expected value of said item not equaling said current value of said item.

15. A structure comprising:
means for comparing an expected value of an item, for which data speculation is desired, with a current value of said item;
means for setting said item to said expected value upon said expected value of said item equaling said current value of said item; and
means for continuing without setting said item to said expected value upon said expected value of said item not equaling said current value of said item.

16. A computer-program product comprising a medium configured to store or transport computer readable code for a method comprising:
comparing an expected value of an item, for which data speculation, is desired with a current value of said item;
setting said item to said expected value upon said expected value of said item equaling said current value of said item; and
continuing without setting said item to said expected value upon said expected value of said item not equaling said current value of said item.

17. A computer system comprising:
a processor; and
a memory coupled to said processor and having stored therein instructions for a data speculation to a control speculation conversion method wherein upon execution of said instructions on said processor said method comprises:
comparing an expected value of an item, for which data speculation is desired, with a current value of said item;
setting said item to said expected value upon said expected value of said item equaling said current value of said item; and
continuing without setting said item to said expected value upon said expected value of said item not equaling said current value of said item.

18. A method for converting a data speculation to a control speculation comprising:
comparing an expected value of an item, for which data speculation is desired, with a current value of said item;
using said expected value of said item upon said expected value of said item equaling said current value of said item in a block of computer code; and
continuing without using said expected value of said item upon said expected value of said item not equaling said current value of said item.

19. The method of claim 18 wherein said block comprises at least one line of computer code.

20. A method for converting a data speculation to a control speculation comprising:
copying a current value of an item, for which data speculation is desired, from a first storage location to a second storage location;
comparing an expected value of said item with said current value of said item;
setting said item to said expected value upon said expected value of said item equaling said current value of said item; and
restoring said current value to said first storage location upon said expected value of said item not equaling said current value of said item.

21. The method of claim 20 further comprising:
continuing without setting the item to the expected value upon said expected value of said item not equaling said current value of said item.

22. A structure comprising:
means for copying a current value of an item, for which data speculation is desired, from a first storage location to a second storage location;
means for comparing an expected value of said item with a current value of said item for which data speculation is desired;
means for setting said item to said expected value upon said expected value of said item equaling said current value of said item for which data speculation is desired; and
means for restoring said current value to said first storage location upon said expected value of said item not equaling said current value of said item.

23. The method of claim 22 further comprising:
means for continuing without setting the item to the expected value upon said expected value of said item not equaling said current value of said item.

24. A computer-program product comprising a medium configured to store or transport computer readable code for a method comprising:
copying a current value of an item, for which data speculation is desired, from a first storage location to a second storage location;
comparing an expected value of said item with said current value of said item;
setting said item to said expected value upon said expected value of said item equaling said current value of said item; and
restoring said current value to said first storage location upon said expected value of said item not equaling said current value of said item.

25. The computer-program product of claim 24 wherein said method further comprises:
continuing without setting the item to the expected value upon said expected value of said item not equaling said current value of said item.

26. A computer system comprising:
a processor; and
a memory coupled to said processor and having stored therein instructions for a data speculation to control speculation conversion method wherein upon execution of said instructions on said processor said method comprises:
copying a current value of an item, for which data speculation is desired, from a first storage location to a second storage location;
comparing an expected value of said item with said current value of said item;
setting said item to said expected value upon said expected value of said item equaling said current value of said item; and
restoring said current value to said first storage location upon said expected value of said item not equaling said current value of said item.

27. The computer system of claim 26 wherein said method further comprises:
continuing without setting the item to the expected value upon said expected value of said item not equaling said current value of said item.
